(19) United States
(12) Patent Application Publication
(10) Pub. No.: US 2024/0342827 A1
(43) Pub. Date: Oct. 17, 2024

(54) DEVICE AND METHOD FOR PROCESSING A WORKPIECE

(71) Applicant: TRUMPF Laser- und Systemtechnik GmbH, Ditzingen (DE)

(72) Inventors: Daniel Flamm, Ludwigsburg (DE); Felix Zimmermann, Ditzingen (DE); Daniel Grossmann, Schramberg (DE)

(21) Appl. No.: 18/679,672

(22) Filed: May 31, 2024

Related U.S. Application Data
(63) Continuation of application No. PCT/EP2022/082501, filed on Nov. 18, 2022.

(30) Foreign Application Priority Data
Dec. 2, 2021 (DE) 10 2021 131 811.4

(51) Int. Cl. B23K 26/064; B23K 26/067; B23K 26/38; B23K 26/70

(52) U.S. Cl. CPC B23K 26/064; B23K 26/0676; B23K 26/38; B23K 26/704

(57) ABSTRACT

A device for processing a workpiece using a laser beam of a laser includes a retarder plate and a focusing device. The retarder plate is configured to apply a first location-dependent phase retardation to a first part of the laser beam having a first input polarization, and to apply a second location-dependent phase retardation to a second part of the laser beam having a second input polarization. The focusing device is configured to focus the laser beam in at least one focus zone. A beam form of the laser beam in the focus zone is determined by the first location-dependent phase retardation and the second location-dependent phase retardation. The at least one focus zone at least partially overlaps with the workpiece. The workpiece is subjected to laser radiation in the at least one focus zone and is thus processed.

### CROSS REFERENCE TO RELATED APPLICATIONS

This application is a continuation of International Application No. PCT/EP2022/082501 (WO 2023/099244 A1), filed on Nov. 18, 2022, and claims benefit to German Patent Application No. DE 102021131811.4, filed on Dec. 2, 2021. The aforementioned applications are hereby incorporated by reference herein.

### FIELD

Embodiments of the present invention relate to a method and a device for processing a workpiece.

### BACKGROUND

In recent years, the development of lasers with very short pulse lengths, especially with pulse lengths below one nanosecond, and with high mean powers, especially in the kilowatt range, has led to a novel type of material machining. The short pulse length and high pulse peak power, or the high pulse energy of a few microjoules to 100 μJ, may lead to nonlinear absorption of the pulse energy within the material, with the result that, for example, it is even possible to machine laser materials that actually are transparent or substantially transparent to the utilized laser light wavelength.

One particular field of application of such laser radiation is the separation and processing of workpieces. In the process, the laser beam is preferably introduced into the material with perpendicular incidence as this minimizes reflection losses at the surface of the material.

For example, the laser radiation can be used to introduce material modifications into the workpiece, wherein the workpiece can be separated by a subsequent application of a thermal gradient along the material modifications.

Such a separating method accordingly has two steps, between which the workpiece either has to be transferred or between which the device for processing the workpiece has to be reconfigured. This can be performed, for example, by exchanging the optical elements and the laser system or individual components, for example, by changing the components in a component revolver or an insert cassette. This means a high expenditure in time and costs.

A further important area of application is machining workpieces at a work angle, for example for beveling a workpiece edge or for producing chamfer and/or bevel structures with work angles of more than 30°, which still represents an unsolved problem, especially also because the large work angles at the material edge lead to a significant aberration of the laser beam, with the result that there cannot be a targeted energy deposition in the material. Furthermore, in this way complex bevels or edge shapes, for example, C bevels or V bevels, can only be implemented with a significant expenditure in material and/or adjustment. For example, using two laser beams adjusted in relation to one another for complex bevels is known from U.S. Pat. No. 10,494,290B2.

### SUMMARY

Embodiments of the present invention provide a device for processing a workpiece using a laser beam of a laser. The device includes a retarder plate and a focusing device. The retarder plate is configured to apply a first location-dependent phase retardation to a first part of the laser beam having a first input polarization, and to apply a second location-dependent phase retardation to a second part of the laser beam having a second input polarization. The focusing device is configured to focus the laser beam in at least one focus zone. A beam form of the laser beam in the focus zone is determined by the first location-dependent phase retardation and the second location-dependent phase retardation. The at least one focus zone at least partially overlaps with the workpiece. The workpiece is subjected to laser radiation in the at least one focus zone and is thus processed.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIGS. 1A, 1B, 1C, and 1D show a schematic representation of a first embodiment of the device;

FIGS. 2A and 2B show a further schematic representation of a first embodiment of the device;

FIGS. 3A, 3B, 3C, 3D, 3E, F3, 3G, and 3H show a schematic representation of a first embodiment of the device and the method for processing a material;

FIGS. 4A and 4B show a further schematic representation of a first embodiment of the device;

FIGS. 5A, 5B, and 5C show a schematic representation of a second embodiment of the device and the method for processing a workpiece; and

FIGS. 6A, 6B, and 6C show a further schematic illustration of a second embodiment of the method.

### DETAILED DESCRIPTION

Embodiments of the present invention provide an improved device for processing a workpiece, as well as a corresponding method.

According to some embodiments, a device for processing a workpiece by means of a laser beam of a laser, comprising a retarder plate and a focusing device, is proposed, wherein the retarder plate is configured to apply a first location-dependent phase retardation to the laser beam having a first input polarization and to apply a second location-dependent phase retardation to the laser beam having a second input polarization, wherein the focusing device is configured to focus the laser beam in at least one focus zone, wherein the beam form of the laser beam in the focus zone is determined by the location-dependent phase retardation, and at least one focus zone at least partially overlaps with the workpiece and the workpiece is subjected to the laser radiation in the at least one focus zone and is thus processed.

In other words, the beam form can be switched by the selection of the input polarization. Efficient switching between two different beam forms can thus be achieved by switching the input polarization. In particular, it is possible to switch between the individual beam forms without exchanging optical components.

A laser can in this case be a continuous wave laser or a pulsed laser, in particular an ultrashort pulse laser, for example. The laser light or the laser pulses move in the beam propagation direction along the unprocessed laser beam formed by the laser.

The unprocessed laser beam has a transverse intensity distribution which is predetermined by and specific to the laser. A transverse intensity distribution should be understood to mean an intensity distribution located in a plane oriented perpendicularly in relation to the beam propagation direction. An unprocessed laser beam can be understood in a certain sense to mean a laser beam composed of a plurality of partial laser beams.

The laser can in particular be an ultrashort pulse laser which provides ultrashort laser pulses. In this context, ultrashort may mean that the pulse length is for example between 500 picoseconds and 10 femtoseconds and in particular between 10 picoseconds and 100 femtoseconds. In the process, the ultrashort laser pulses move in the beam propagation direction along the laser beam formed thereby.

The laser beam is incident on a retarder plate. The retarder plate is configured to apply a phase delay to the laser beam as a function of the incidence location during the passage through the retarder plate. The retarder plate can in particular have a location-dependent birefringent structure.

A retarder plate modulates the phase of the incident laser beam. Each component of the optical field (Ex, Ey) can perceive a different retardation, which in general results in a change of the polarization. Examples of this are half-wave or quarter-wave retarder plates.

Retarder plates having spatially dependent birefringent structure are described, for example, in J. Kim et al. “Fabrication of ideal geometric-phase holograms with arbitrary wavefronts” Optica Vol. 2, 958 (2015). Optical path length differences are implemented by birefringent elements in which the measure of the birefringence is a function of the position. The optical path length difference thus induced and the difference of the phase of the field components is also called the geometrical phase effect (see the above-mentioned reference). For this purpose, a birefringent structure is introduced into a carrier material to produce a retarder plate, for example, by inscribing a nanograting which is introduced with the aid of ultrashort laser pulses. The birefringent structure permits a polarization-dependent phase modulation to be performed in this case, wherein in particular the degree of the modulation can be influenced via the form of the birefringent structure (thickness and alignment of the nanograting).

Birefringence means the ability of an optical material to separate the incident laser beam into two partial laser beams polarized perpendicularly to one another. This occurs because of different refractive indices of the optical material as a function of the polarization and the angle of incidence of the light relative to the optical axis of the optical material.

In the context of this application, partial laser beams polarized perpendicularly to one another mean linearly polarized partial laser beams, the polarization directions of which have an angle of 90° with respect to one another. Partial laser beams polarized perpendicularly to one another also mean, however, circularly polarized partial laser beams having opposite directions of rotation, i.e., left or right circularly polarized partial laser beams.

When the laser beam is incident on the retarder plate, the laser beam is thus projected locally onto the local optical axis of the retarder plate. In other words, the laser beam is decomposed into two partial laser beams, the polarization of which is parallel or perpendicular, respectively, to the local optical axis. The index of refraction of the material is specified in this case via the so-called index ellipsoids, the main axes of which are the so-called base polarization components. For example, the retarder plate can locally have a greater index of refraction for perpendicularly polarized laser beams than for laser beams polarized parallel to the optical axis. Due to the different indices of refraction (and the reduced speed of light c/n linked thereto), the partial laser beams have a phase retardation upon emerging from the retarder plate. A phase front of the laser beam may thus be formed via a locally set optical axis of the retarder plate.

In particular the beam form of the laser beam can be determined here by the phase front of the laser beam. For example, refracting and non-refracting beams or beam forms can be generated by a corresponding phase front, as shown below.

The retarder plate can be configured such that a first input polarization of the laser beam has a first location-dependent phase retardation applied, while a second input polarization of the laser beam has a second location-dependent phase retardation applied.

For example, the first and the second input polarization can be oriented perpendicularly to one another. Accordingly, for example, the projection of the laser beam having the first input polarization on the local optical axis can take place in a dominant manner on the first base polarization component, while the projection of the second input polarization on the local optical axis can take place in a manner dominant on the second base polarization component. Accordingly, the phase shift locally has different dimensions and is thus dependent on the input polarization, in particular is dependent on the two different input polarizations.

Taken over the area of the retarder plate, a first location-dependent phase retardation can thus be generated using a first input polarization of the laser beam and a second location-dependent phase retardation can be generated using a second input polarization of the laser beam. In particular, a first and second phase front can thus also be generated using a first and second input polarization.

In other words, the retarder plate can provide the location-dependent phase retardation by way of the local polarization projection of the input polarization of the laser beam on the location-dependent birefringent structure of the retarder plate.

The focusing device can transfer the location-dependent phase retardation into at least one focus zone.

The focus zone of the laser beam is understood as the part of the intensity distribution of the laser beam that is greater than the modification threshold of the workpiece. The term focus zone makes it clear here that this part of the intensity distribution is specifically provided and an intensity boost in the form of the intensity distribution is achieved by focusing.

A focusing device can be, for example, a telescope or a lens or a lens system in this case. A telescope is an optical structure which enables imaging of the laser beam and provides it in or on the workpiece. In particular, such a telescope can have a magnifying and/or shrinking effect.

In particular, a part of the optical functionality of the telescope may be integrated in the retarder plate. For example, the retarder plate can have a further location-dependent phase retardation in addition to a first location-dependent phase retardation, wherein the further location-dependent phase retardation corresponds to the phase retardation which a lens applies to a laser beam as it passes through the lens. The retarder plate can thus unify a lens effect with a location-dependent phase retardation. A telescope can thus also be constructed having a retarder plate and a lens.

A magnification and/or a shrinking of the laser beam or its transverse intensity distribution allows the laser energy to be distributed over a large or small focal zone. As a result of distributing the laser energy over a large or small area, the intensity is adapted such that, in particular, it is also possible to make a choice between modification types I, II and III by way of the magnification and/or shrinking of the laser intensity, as shown below.

When an ultrashort laser pulse is focused into a material of the workpiece, the intensity in the focal volume may lead to nonlinear absorption, for example by multi-photon absorption and/or electron avalanche ionization processes. This nonlinear absorption leads to the generation of an electron-ion plasma, and permanent structural modifications may be induced in the material of the workpiece when said plasma cools.

The material modifications caused in transparent materials by ultrashort laser pulses are subdivided into three different classes: see K. Itoh et al. “Ultrafast Processes for Bulk Modification of Transparent Materials” MRS Bulletin, vol. 31, p. 620 (2006): Type I is an isotropic refractive index change; Type II is a birefringent refractive index change; and Type III is what is known as a void or cavity that is produced by so-called micro-explosions. In this respect, the material modification created depends on laser parameters such as the pulse duration, the wavelength, the pulse energy and the repetition frequency of the laser, on the material properties such as, among other things, the electronic structure and the coefficient of thermal expansion, and also on the numerical aperture (NA) of the focusing.

The type I isotropic refractive index changes are traced back to locally restricted fusing by way of the laser pulses and rapid resolidification of the transparent workpiece. For example, quartz glass has a higher density and refractive index of the workpiece if the quartz glass is cooled quickly from a higher temperature. Thus, if the workpiece in the focal volume melts and then cools rapidly, the quartz glass has a higher refractive index in the regions of the material modification than in the unmodified regions.

The type II birefringent refractive index changes may arise, for example, due to interference between the ultrashort laser pulse and the electric field of the plasma generated by the laser pulses. This interference leads to periodic modulations in the electron plasma density, which leads to a birefringent property, which is to say directionally dependent refractive indices, of the transparent material upon solidification. A type II modification is, for example, also accompanied by the formation of what are known as nanogratings.

The voids (cavities) of type III modifications may, for example, be generated with a high laser pulse energy. The formation of the voids is in this case attributed to an explosive expansion of highly excited vaporised material from the focal volume into the surrounding material. This process is also referred to as microexplosion. Since this expansion occurs within the mass of the material, the micro-explosion results in a less dense or hollow core (the void) or a defect in the sub-micrometer range or in the atomic range, which void or defect is surrounded by a densified material envelope. The compaction at the shock front of the microexplosion creates stresses in the workpiece, which may lead to spontaneous crack formation or may promote crack formation.

In particular, the formation of voids may also be accompanied by type I and type II modifications. By way of example, type I and type II modifications can arise in the less stressed areas around the introduced laser pulses. Accordingly, if reference is made to the introduction of a type III modification, then a less dense or hollow core or a defect is present in any case. By way of example, it is not a cavity but a region of lower density that is produced in sapphire by the micro-explosion of the type III modification. Due to the material stresses that arise in the case of a Type III modification, such a modification moreover often is accompanied by, or at least promotes, a formation of cracks. The formation of type I and type II modifications cannot be fully prevented or avoided when introducing type III modifications. “Pure” type III modifications are therefore not likely to be encountered.

In particular, it is possible to separate the workpiece along a separating line by way of the material processing. For this purpose, the device can have a feed device which is configured to move the workpiece and the laser field relative to one another with a feed along a trajectory, as explained in more detail below.

The material modifications are introduced into the workpiece along a trajectory. The trajectory describes the line of incidence of the laser field on the surface of the workpiece in this case. For example, the laser beam and the workpiece are displaced relative to one another at a feed speed as a result of a feed, with the result that the laser pulses are incident on the surface of the workpiece at different locations as time passes.

One advantage of the device according to embodiments of the invention is that for two successive method steps for processing a workpiece, a simple option is provided for switching between two beam forms, so that the successive method steps can accordingly be executed using different beam forms. In particular, it is sufficient here to change the input polarization of the laser beam, which is connected to significantly less effort than the known solutions of the prior art.

The first location-dependent phase retardation can be conical and lens-like and/or the second location-dependent phase retardation can be constant.

A constant location-dependent phase retardation has the same value at every point of the laser beam. For example, the laser beam is homogeneously retarded as it passes through the retarder plate. A constant phase retardation of a Gaussian laser beam has the result that in the laser beam passing through the retarder plate, the phase front of the laser beam remains unchanged. The laser beam is thus also still a Gaussian laser beam after the retarder plate.

A conical and lenticular phase retardation follows equation φ=a·r+b·r², wherein a is the cone constant, b is the lens constant, and r is the distance to the beam center of the laser beam. In other words, the conical component of the phase retardation is set linear with the distance r and the lenticular component of the phase retardation is set square with the distance r. A conical phase retardation and a lens effect are provided at the same time by the retarder plate.

The phase retardation accordingly rises with increasing distance to the beam center or falls. To a certain extent, the aperture angle of the cone can be determined using the cone constant a, which results if the laser beam were incident through an axicon. A phase retardation which corresponds to the phase retardation upon the passage through a lens can be generated by the term b·r². In particular, a lens function can thus be implemented jointly with a location-dependent phase retardation as described above.

This has the advantage that the Gaussian laser beam can be focused using a single downstream lens of the focusing device. The laser beam having the conical and lenticular phase retardation, in contrast, can still have the conical phase retardation after the passage through the focusing device, so that a non-diffracting laser beam is generated.

In particular, the laser beam having the constant phase retardation in the focus zone can thus have a Gaussian beam form and/or the laser beam having the conical and lenticular phase retardation can have a quasi-non-diffractiive beam form in the focus zone.

With respect to the definition and properties of quasi-non-diffractive and non-diffractive beams, reference is made to the book: “Structured Light Fields: Applications in Optical Trapping, Manipulation and Organisation”, M. Wördemann, Springer Science & Business Media (2012), ISBN 978-3-642-29322-1. Full explicit reference is made thereto.

Accordingly, nondiffractive laser beams have the advantage that they can have a focal zone which is elongated in the beam propagation direction and is significantly larger than the transverse dimensions of the focal zone. In particular, this makes it possible to generate a material removal or material modification which is elongate in the beam propagation direction, in order to ensure easy separation of a workpiece, for example.

In particular, non-diffractive beams make it possible to produce elliptical non-diffractive beams which have a non-radially symmetrical transverse focus zone. For example, elliptical quasi-non-diffractive beams have a principal maximum which coincides with the center of the beam. The center of the beam is given here by the location at which the principal axes of the ellipse intersect. In particular, elliptical quasi non-diffractive beams may emerge from the superposition of a plurality of intensity maxima, with in this case only the envelope of the intensity maxima involved being elliptical. In particular, it is not necessary for the individual intensity maxima to have an elliptical intensity profile.

For example, a non-diffractive beam can be generated from a flat wave field or from parallel partial laser beams if all the partial laser beams are refracted at the same angle β to the optical axis of the laser beam. As a result, near-axis partial laser beams already overlap on the optical axis shortly after the processing laser beamforming optical unit and therefore form an increased laser intensity, while off-axis beams only overlap later after the processing laser beamforming optical unit and form an increased laser beam intensity. Therefore, a substantially constant laser intensity can be produced over a longitudinal length parallel to the direction of beam propagation. A laser beam in which all partial laser beams are diffracted at the same angle β in relation to the optical axis is called an ideal non-diffractive reference beam.

The location-dependent birefringent structure can be a nanograting.

A nanograting can mean that a local optical axis can be set at all grating points of the grating. In particular a certain regularity is intrinsic to the grating. If a nanograting has, for example, 10×10 grating points, then the optical axis of the birefringent structure can be set at each of the 100 grating points. The more grating points are used, the more accurately the location-dependent phase retardation can be set and the more accurately a phase front of the laser beam can be set.

The nanograting can preferably be provided in a transparent carrier material as a type II modification, wherein the carrier material is preferably quartz glass.

These nanogratings are configured in their strength (refractive index difference) and alignment (main axes of the index ellipsoid) by the laser parameters of the ultrashort pulse writing laser. For example, the nanograting can be locally configured via the polarization, the pulse energy, and the pulse interval.

A polarizer element can be configured to set the polarization of the laser beam, wherein the polarizer element is arranged before the focus zone, preferably before the focusing device, preferably before the retarder plate.

A polarizer element can be a polarizer, for example, such as a thin film polarizer. For example, a specific polarization direction can be filtered out of the laser beam by a polarizer.

The input polarization can accordingly be set by the polarizer element and switching between different beam forms can thus be enabled.

For example, a circularly-polarized laser beam can be guided onto the retarder plate. The circularly-polarized laser beam is composed of a s-polarized component and a p-polarized component, wherein both components are phase-shifted in relation to one another. The s-polarized component has a first location-dependent phase retardation applied by the retarder plate and the p-polarized component has a second location-dependent phase retardation applied by the retarder plate. Both polarization components having the different location-dependent phase retardations are superimposed after the retarder plate.

If the polarizer is arranged before the focus zone, a polarization component of the laser beam having the superimposed phase retardations can be introduced into the material. If the polarizer is arranged after the retarder plate and before the focusing device, likewise only one polarization component of the laser beam having the superimposed phase retardations can be introduced into the material.

If the polarizer is arranged before the retarder plate, a linear polarization component of the circularly polarized laser beam can be selected thereby. If the polarizer is set so that the input polarization of the laser beam corresponds to a first polarization determined by the retarder plate, only the first location-dependent phase retardation is then generated by the retarder plate. If the polarization of the laser beam corresponds to a second polarization determined by the retarder plate, only the second location-dependent phase retardation is then generated by the retarder plate.

However, the polarizer can also be set so that a first part of a s-polarization and a second part of a p-polarization is transmitted by the polarizer. The proportions of the first and second location-dependent phase deceleration may thus also be determined via the proportions of the polarizations. Furthermore, the intensity of the different beam forms in the focus zone or zones can be determined by the selection of the input polarization. In other words, the relative power of the different beam parts may be set by setting the input polarization of the laser beam.

A polarizer component can also comprise a wave plate, however, using which the conversion of linearly polarized partial laser beams having polarization directions aligned perpendicular to one another into circularly polarized partial laser beams having opposite rotational direction can take place. In particular, the device can have a quarter-wave plate, which is configured to convert a circular polarization of the incident laser beam into a linear polarization or a linear polarization into a circular polarization, wherein the quarter-wave plate can be arranged before the retarder plate in the beam propagation direction.

It is thus possible to generate a right-hand circular or left-hand circular polarized laser beam from a s-polarized or p-polarized laser beam. However, it is also possible to form right-hand circular or left-hand circular polarized laser beams from the s-polarized or p-polarized laser beams.

In particular, the use of a quarter-wave plate enables flexibility in the design of the device. In particular, however, a polarization dependence of the material processing can also be taken into consideration here, so that the workpiece can be processed with particularly high quality.

It is also possible that the polarizer element comprises a rotatable quarter-wave plate and/or a half-wave plate and/or a Pockels cell. For example, the polarization setting can be varied and/or set during the processing process by the rotation, so that a continuous and rapid change of the input polarization is enabled. A Pockels cell rotates the polarization of the passing laser beam proportionally to an applied voltage here, so that in this way in principle switching of the polarization states is enabled.

A beamforming element can be configured for the purpose of carrying out beamforming and/or beam multiplication. The beamforming element can be arranged after the retarder plate in the beam propagation direction here.

The beamforming element can be, for example, a diffractive optical element (DOE). A diffractive optical element is configured to influence the incident laser beam in one or more properties in two spatial dimensions. A diffractive optical element is a fixed component which can be used to generate an intensity distribution of the laser beam. A diffractive optical element may also be suitable for splitting an incident laser beam into a plurality of partial laser beams. Typically, a diffractive optical element is a specially designed diffraction grating, wherein the incident laser beam is brought into the desired beam form or is transferred into the desired intensity distribution by the diffraction.

In this case, for example, the number of partial laser beams can be established via the diffractive optical element. In particular, the diffractive optical element can establish whether the split partial laser beams are on a one-dimensional line or a two-dimensional grating. The splitting may in this case be brought about independently of the polarization of the laser beam. In particular, the polarization of the laser beam is maintained when passing through the diffractive optical element.

The beamforming element can in particular be an etched microstructure, wherein preferably the beamforming element consists of or comprises fused silica.

The beamforming element can have at least two zones, wherein the first zone can be configured to perform a first beam multiplication and/or beamforming and thus provide a first beam part and wherein the second zone can be configured to perform a second beam multiplication and/or beamforming and thus provide a second beam part.

A first zone and a second zone are spatial sections of the beamforming element which exist separately from one another. For example, the upper half and the lower half of the beamforming element can form the first and second zone.

The laser beam which is incident on the first zone can be multiplied, for example, by the diffractive optical element, while a laser beam which is incident on the second zone is only transmitted. However, the two zones can also induce different multiplication.

The first zone of the beamforming element can be a central zone and the second zone can be a neutral outer zone.

In particular, the beamforming element can thus be divided into radial segments. A radial segment is a round section or an annular section, wherein the center point of the section coincides with the center of the beamforming element.

For example, a first round section can be produced around the center of the beamforming element, for example, having a first radius. For example, a second annular section can be produced around the center, the outer radius of which is a second radius and the inner radius of which is the first radius. For example, the diffractive optical element may not be etched in the second zone, but rather neutral, so that it only transmits the laser beam incident thereon.

In the first zone of the beamforming element, a beam multiplication of the incident laser beam can be performed, wherein the focus zones can be arranged by the first zone of the beamforming element in three spatial dimensions, in particular can be arranged along a separating line. The first zone of the beamforming element can preferably therefore be a 3D beam splitter.

By the laser beam being incident on the first zone of the beamforming element, the laser beam can be decomposed into a plurality of partial laser beams. In particular, each partial laser beam has the same phase front as the incident laser beam in this case. A plurality of identical focus zones can accordingly be generated by the focusing device.

The focus zones can be arranged in three spatial dimensions. For example, the focus zones can lie in a plane which is perpendicular to the beam propagation direction. The focus zones can also lie in a plane which is tilted by an angle in relation to the beam propagation direction. Accordingly, the focus zones have different introduction depths or the focus zones are generated along different depths of the beam propagation direction.

In particular, the beam is split in three spatial dimensions by an above arrangement. The first zone thus functions as a so-called 3D beam splitter.

The first zone of the beamforming element can receive the laser beam with a constant phase retardation and provide a plurality of Gaussian focus zones after the focusing device, which are arranged on a separating line, wherein preferably the processing is that the workpiece is beveled along the separating line.

For example, the plurality of Gaussian focus zones can be arranged in a plane in which the beam propagation direction lies and the surface normal of which is the feed vector. In particular, the Gaussian focus zones can also be arranged in the plane along a separating line. This separating line can be linear or curved, for example, and can be at an angle to the surface of the workpiece.

At the same time, however, each partial laser beam which forms the Gaussian focus zones can be incident perpendicularly on the surface of the workpiece. In particular reflection losses on the surface of the workpiece can thus be avoided. The use of an optical processing wedge can also be avoided.

In particular, a separating plane can thus be defined on the workpiece, along which the workpiece is to be beveled. The separating plane is defined in this case by the entirety of the separating lines overlapping with the workpiece during the feed.

The second zone of the beamforming element can receive the laser beam having the conical phase retardation and provide a focus zone elongated in the beam propagation direction, wherein preferably the processing is that the workpiece is separated along the focus zone elongated in the beam propagation direction.

The elongated focus zone can be oriented perpendicular to the surface of the workpiece in this case. In particular, the elongated focus zone can be longer in the beam propagation direction than the thickness of the workpiece. It is thus possible to introduce material modifications into the workpiece, so that the workpiece can be separated along the separating plane. In particular, the workpiece is shortened or brought into shape by such a separation.

In particular, a further separating plane can thus be defined on the workpiece, along which the workpiece is to be separated. The further separating plane is defined in this case by the entirety of the elongated focus zones with the workpiece during the feed.

The separating line and the feed can define a first separating plane as described and the elongated focus zone and the feed can define a second separating plane, wherein the first separating plane and the second separating plane can intersect, by which the workpiece is simultaneously separated along the focus zone elongated in the beam propagation direction and beveled along the trajectory.

The described device and the described method can accordingly be used in a process for producing a beveled glass edge. For this purpose, for example, in a first pass using an elongated focus zone, a box shape having perpendicular walls is generated and after switching the beam form, in a second pass, a surface removal is then generated using a Gaussian focus zone at the end of the generated modification, which can have a taper angle. After the separating of the workpiece, a beveled glass edge having dimensions of 10 μm to 50 μm can then result, for example, at a taper angle between 10° and 45°.

The device can furthermore have a feed device, using which the feed is generated. By way of example, in this case the feed device can be an XY stage or an XYZ stage, in order to vary the point of incidence of the laser pulses on the workpiece. In this case, the feed device can move the workpiece and/or the laser beam so that the material modifications can be introduced into the material of the workpiece, next to one another along the separation line. The above-mentioned separating planes can thus be defined.

The feed device may comprise an axis device and a workpiece holder which are configured to move the processing optical unit and the workpiece relative to one another along three spatial axes translationally and around at least two spatial axes rotationally.

By way of example, an axis device can be a 5-axis device. By way of example, the axis device can also be a robotic arm which guides the laser beam over the workpiece or which moves the workpiece in relation to the laser beam.

In particular, such an axis device at the same time also allows a non-radially symmetric transverse intensity distribution of a non-diffractive laser beam to be oriented relative to the feed direction, so that material modifications are produced, the preferred directions of which extend parallel to the feed trajectory and which promote a crack formation along the latter.

Moreover, an axis device may also comprise fewer than the 5 movable axes as long as the workpiece holder is movable about the corresponding number of axes. By way of example, if the axis device is only displaceable in the XYZ-directions, then the workpiece holder may for example have two rotational axes in order to rotate the workpiece relative to the laser beam.

A beam guiding device can be configured to guide the laser beam to the device, wherein the beam guiding device is produced via a mirror system and/or an optical fiber, preferably a hollow core fiber.

A so-called free-beam guidance uses a mirror system in order to guide the laser beam in various spatial dimensions from a stationary ultrashort pulse laser to the beamforming optical unit. A free-beam guidance is advantageous in that the entire optical path is accessible, and so for example further elements such as a polarizer and a waveplate can be installed without problems.

A hollow core fiber is a photonic fiber which is able to flexibly transmit the laser beam from the ultrashort pulse laser to the beamforming optical unit. The adjustment of the mirror optical unit can be dispensed with as a result of the hollow core fiber.

Control electronics can be configured to trigger a laser pulse emission of the ultrashort pulse laser on account of the relative positions of laser beam and workpiece.

A local reduction in the feed speed may be advantageous in the case of curved or polygonal feed trajectories. However, in the case of a constant repetition frequency of the laser, this may lead to the material modification area not being formed homogeneously, with the result that a uniform surface quality cannot be obtained during the separation step. For this reason, control electronics are able to control the pulse emission on the basis of the relative position of laser beam and workpiece.

By way of example, the feed device may comprise a position resolving encoder which measures the position of the feed device and laser beam. An appropriate trigger system of the control electronics may trigger the pulse emission of a laser pulse at the ultrashort pulse laser on the basis of the spatial information.

In particular, computer systems may also be used to trigger the pulses. By way of example, the locations of the laser pulse emission may be defined for the respective separation line prior to the machining of the material, with the result that an optimal distribution of the material modifications along the separation line is ensured.

In this way the spacing of the material modifications is always the same, even if the feed speed varies. In particular, in this way it is possible to produce a uniform separation surface, and the chamfer or bevel has a high surface quality.

The workpiece holder may have a surface that does not reflect and/or does not scatter the laser beam.

In this way, the laser beam which penetrates the workpiece is not reflected back to the workpiece and does not perform a material modification there again.

The object stated above is also achieved by means of a device for separating a workpiece having the features of claim 13. Advantageous refinements of the method may be found in the dependent claims, the present description, and the figures.

Accordingly, a method for separating a workpiece by means of a laser beam of a laser is proposed, wherein a first location-dependent phase retardation is applied to the laser beam having a first input polarization by a retarder plate and a second location-dependent phase retardation is applied to the laser beam having a second input polarization by the retarder plate, wherein the laser beam is focused using a focusing device in at least one focus zone, wherein the beam form of the laser beam in the focus zone is determined by the location-dependent phase retardation, wherein at least one focus zone at least partially overlaps with the workpiece and the material of the workpiece is subjected to the laser radiation in the at least one focus zone and is thus processed.

The first location-dependent phase retardation can be conical and lenticular and/or the second location-dependent phase retardation can be constant and the laser beam having the constant phase retardation can be mapped by the focusing device in a Gaussian focus zone and/or the laser beam having the conical phase retardation can be mapped in a focus zone elongated in the beam propagation direction.

In a first method step, a laser beam having a focus zone elongated in the beam propagation direction can be generated using a first input polarization, wherein the beam propagation direction is oriented perpendicular to the material surface, and material modifications are introduced into the workpiece by the application to the workpiece, and in a second method step at least one Gaussian focus zone, which overlaps with at least one material modification, can be generated using a second input polarization, and the workpiece is separated by the thermal application in the focus zone along the elongated material modifications.

The described device and the described method can accordingly be used as a self-separating process, in which the workpiece is separated without the action of further mechanical forces. In a first pass, material modifications can accordingly be introduced using the laser beam, and after switching the beam form, in a second pass, the separating process is then initiated by the thermal application along the material modifications.

A thermal gradient is generated in the workpiece by the thermal application in the Gaussian focus zone. A thermal gradient can mean that the temperature on and/or in the workpiece is not homogeneously distributed. For example, there can be a thermal gradient between two surfaces of the workpiece. The temperature is then higher at an upper surface than at a lower surface. However, there can also be a temperature distribution on a surface or in a plane of the workpiece. For example, the workpiece can then be warmer at a point A of the upper surface than at a point B of the same upper surface. A so-called thermal gradient then results between the points A and B.

If the thermal gradient extends over the material modification, this means, for example, that different temperatures are present within the spatial extension of the material modification or the material modification region. However, this can also mean that the material modification is only within the temperature profile described by the thermal gradient. In particular, the temperature then does not need to change within the spatial extension of the material modification region.

This has the advantage that the workpiece heats up to different extents at different points. Material tensions can be introduced into the workpiece by the differing thermal expansion of the workpiece resulting therefrom. The workpiece was deliberately weakened by the material modifications in the first method step, so that the workpiece cracks and/or breaks starting from the material modification or the material modifications due to the thermal gradient.

The workpiece can therefore be separated by the thermal application along the separating plane.

The beamforming element can transfer the laser beam having the constant phase retardation into a plurality of Gaussian focus zones, wherein the focus zones are arranged in three spatial dimensions, in particular along a separating line which is at an angle to the beam propagation direction, by which the workpiece is beveled.

The laser beam having the conical phase retardation can be transferred into an elongated focus zone, by which the workpiece is separated.

The laser beams having mixed polarization can simultaneously bevel and separate the material of the workpiece, wherein the relative power of the various beam parts is set by setting the polarization of the laser beam.

In a further application, the described device and the described method can be used to remove a coating before the actual glass separation. For this purpose, the coating is initially removed locally by application of a Gaussian focus zone to the coated glass substrate and after switching the beam form, separating is then initiated by introducing an elongated modification by means of an elongated focus zone.

In a further application, the described device and the described method can be used to join complex components. In this case, for example, during a pass, the focus zones can be switched in accordance with the geometry of the interfaces presently to be joined by switching between different focus zones.

Preferred exemplary embodiments will be described below with the aid of the figures. Elements which are the same or similar, or which have the same effect, are provided with identical reference signs in the various figures, and a repeated description of these elements is sometimes omitted in order to avoid redundancies.

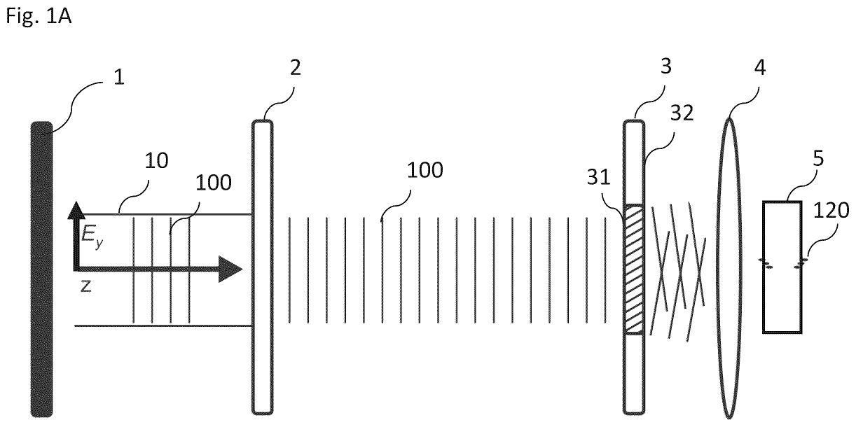

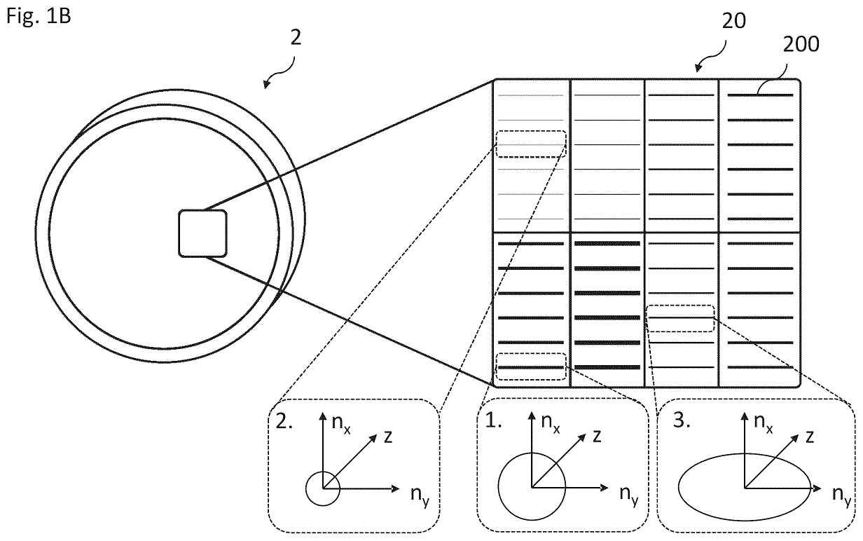

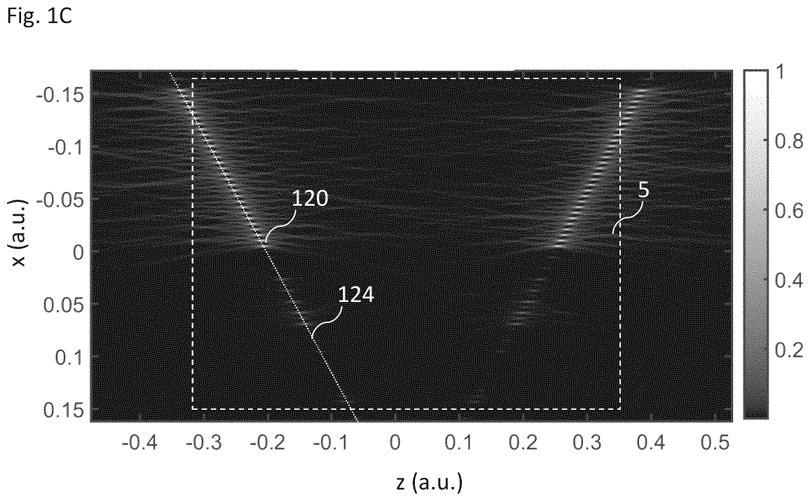

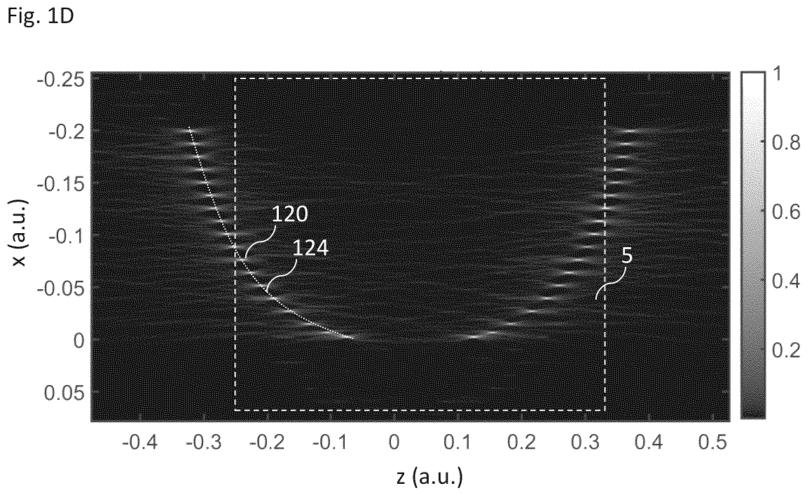

FIG. 1 schematically shows a first embodiment of the proposed device.

The device comprises a laser 1, a retarder plate 2, a beamforming element 3, and a focusing device 4 here. The laser 1 provides a laser beam 10, which propagates along the z axis. The laser beam 10 has a certain input polarization, which in the present case is a p polarization. The electrical field vector E_{y} is thus polarized parallel to the y axis. The laser beam 10 having the p polarization is incident on the retarder plate 2. The retarder plate 2 is configured to apply a second location-dependent phase retardation (the first polarization and the first location-dependent phase retardation are described below) to a laser beam 10 having a second polarization. The functionality of the retarder plate 2 is explained below. The second phase retardation is a constant phase retardation in the present case. Accordingly, only a constant phase retardation is applied to the laser beam 10. In particular, the phase front 100 of the laser beam 10 is not influenced in this case. In particular, a Gaussian laser beam 10 having the second polarization remains a Gaussian laser beam 10 after passing through the retarder plate 2.

A retarder plate 2 is shown in detail in FIG. 1B. The retarder plate has birefringent structures 200 in this case, which are aligned along a grating or along the grating points of a grating. The birefringent structures 200 are accordingly embodied here as grating elements of a nanograting 20. The birefringent structures 200 can be inscribed, for example, as a type II modification into a quartz glass.

When a laser beam 10 is incident on the nanograting 20, the laser beam 10 is retarded by different degrees by the locally differently acting birefringence. A location-dependent phase retardation can thus be applied to the laser beam 10.

For example, in a first case the index ellipsoid of the grating element is a sphere. Accordingly, the refractive indices along the x axis nₓ and the y axis n_{y} are equal. During the passage through the retarder plate, both the x polarization component and the y polarization component of the laser beam 10 experience an equal phase shift:

$$\\ {ϕ}_{x} = \frac{2 π}{{λ}_{0}} {dn}_{x} , {ϕ}_{y} = \frac{2 π}{{λ}_{0}} {dn}_{y}$$

Wherein λ₀ is the wavelength of the laser beam 10 and d is the local thickness of the retarder plate.

In a second case, the refractive index is again a sphere, however, the refractive indices along the x and y axes are less than in the first case. The part of the laser beam 10 which is incident on the second section is thus retarded less strongly in the phase than the part of the laser beam which is incident on the first section.

In a third case, the refractive indices along the x and y axes are different. Accordingly, the polarization components of the laser beam are retarded by different degrees. If a laser beam 10 is polarized in the x axis, the phase retardation is than less, for example, than if the laser beam were y-polarized. In particular, it is clear in this way how the retarder plate can generate a location-dependent phase retardation, namely by providing different index ellipsoids locally, which retard the laser beam 10 depending on polarization.

In a simple example, a phase retardation of a lens is to be imitated. In a lens, the phase retardation is typically generated by the variation of the thickness d of the optical material at constant refractive index n. As shown above, the thickness d of the optical material and also the refractive index are incorporated linearly in the phase retardation. Accordingly, a lens effect can also be induced if the refractive index n is changed at constant material thickness d. For example, a retarder plate 2 can act as a converging lens if the refractive index is large in the center of the retarder plate 2 and steadily drops radially. The retarder plate can now have index ellipsoids, the x components of which have such a variation of the refractive index. Accordingly, such a retarder plate 2 would act like a lens for a x-polarized laser beam.

At the same time, the index ellipsoids in the y component can have a constant value. The location-dependent phase retardation for a y-polarized laser beam is then equal everywhere, so that the entire laser beam 10 is retarded uniformly, as shown in FIG. 1A. The laser beam 10 tan which emerges from the retarder plate 2 thus has a homogeneous phase retardation, or the laser beam 10 has parallel phase fronts 100.

The laser beam 10 then passes through a beamforming element 3. The beamforming element 3 has two zones 31, 32 here. The first zone 31 causes, for example, a beam multiplication of the incident laser beam 10. The first zone 31 can be formed, for example, by a diffractive optical element, so that the incident laser beam 10 can be split into the desired number of partial laser beams.

The diffractive optical element can be, for example, a diffractive or holographic 3D beam splitter, see Flamm, Daniel, et al. “Structured light for ultrafast laser micro- and nanoprocessing” Optical Engineering 60.2 (2021): 025105. Full explicit reference is made thereto.

The partial laser teams are focused via a focusing device 4. Focus zones 120 are formed in this case, the position of which is established by the beamforming element or the first zone 31 of the beamforming element 3.

To process a workpiece 5, it is brought into overlap with at least one focus zone 120. The workpiece 5 can thus be locally subjected to the laser energy of the laser 1. The functionality of the processing is presented below here.

FIG. 1C shows a simulation of an intensity distribution which can be generated using the device from FIG. 1A. In addition, the cross section of a cuboid workpiece 5 is shown here as an example, which is brought into overlap with the focus zone 120 in order to enable processing.

A plurality of Gaussian focus zones 120 can be generated by the device and in particular the beamforming element 3. These focus zones 120 have different introduction depths, thus arise at different z coordinates. The focus zones 120 are moreover arranged along a separating line 124. Material modifications (not shown) are generated along the separating line 124 by the application of laser radiation to the workpiece 5. If the workpiece 5 or the laser beam 10 is fed along the x axis using a feed device, a separating plane in which the separating lines 124 lie then results. The workpiece 5 can be separated along the separating plane.

In particular, the separating plane is at an angle to the surface of the cuboid. Such an angled separating plane can only be generated in the prior art if the laser beam 10 is incident at an angle on the surface of the workpiece 5, which results in large aberration losses. In the present case, however, a plurality of focus zones 120 can be generated via the beamforming element 3, wherein the partial laser beams for generating the focus zones 120 are each orthogonal to the surface of the workpiece 5. The aberration losses thus disappear and the effectiveness of the separating process is increased.

FIG. 1D shows a further possible intensity distribution, which can be generated using the device in FIG. 1A. The separating line 124, which is composed of the plurality of focus zones 120, is curved in this case. Optically challenging bevels of the workpiece 5 are thus possible.

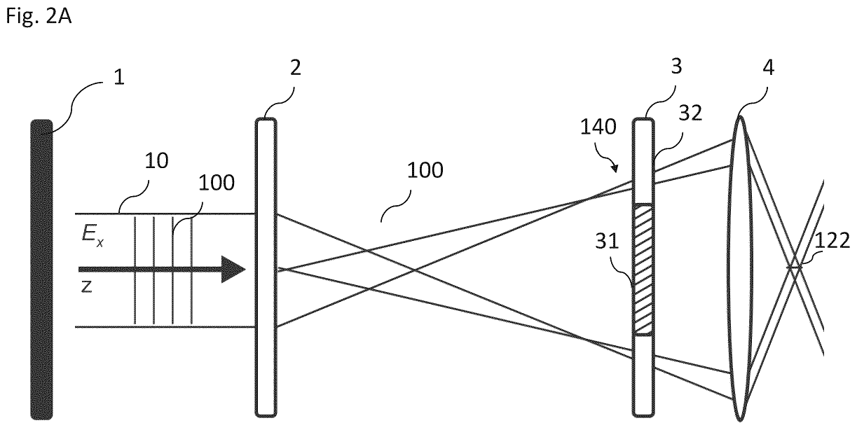

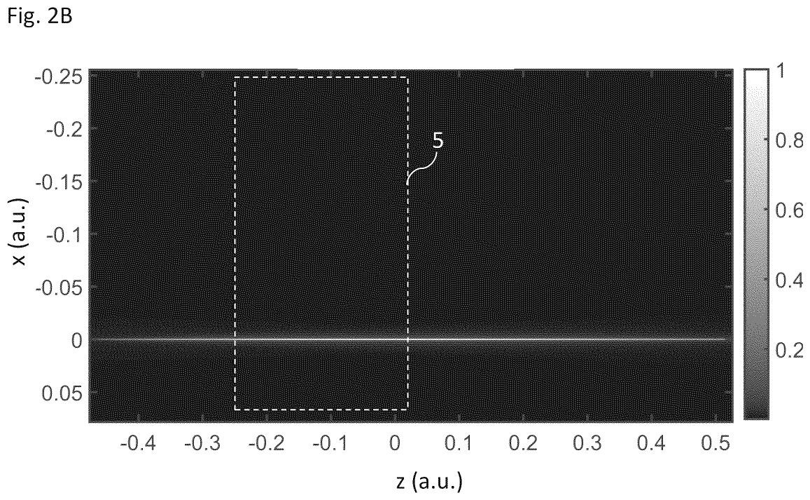

FIG. 2A shows the device from FIG. 1A, but with the difference that the laser beam 10 has a second input polarization. In particular, the laser beam 10 is now a s-polarized laser beam 10, so that the electrical field vector Ex protrudes into the plane of the page. A second location-dependent phase retardation, which also has a lens effect, among other things, is applied to the laser beam 10 having the second input polarization by the retarder plate 2 designed as a beamforming element. For example, the index ellipsoids can additionally have different sizes in the x component. In particular, the phase front of the outgoing laser beam 10 can be set in this way. In the present case, the phase front of the laser beam is set by the consideration of the lens effect so that a so-called far field ring 140 arises in the far field. This can be effectuated in that a conical phase retardation having lens effect is applied to the laser beam 10 as it passes through the retarder plate.

In other words, the beam form can be switched by the selection of the input polarization.

In particular, such a far field ring 140 can pass through the second zone 32 of the beamforming element 3. It can be seen clearly in the cross section of the device that the laser beam 10 only passes through the second zone 32 of the beamforming element 2 unobstructed. In particular, this second zone 32 can be a neutral zone in which the laser beam 10 is not deflected or influenced.

The laser beam 10 is then focused by the focusing device 4, so that the laser beam 10 is transferred into an elongated focus zone 122. The focus zone 122 is elongated here in the beam propagation direction (thus the z direction).

FIG. 2B shows an intensity distribution which can be generated using the device from FIG. 2A. In contrast to FIGS. 1C and 1D, only one continuous elongated focus zone 122 is generated here. The length of the elongated focus zone 122 significantly exceeds the thickness of the workpiece 5 here, so that the workpiece 5 can be processed over the entire thickness.

The discussed cases of FIGS. 1 and 2 are special cases, in which the polarization of the laser beam 10 corresponds to one of the polarization directions specified by the retarder plate 2. In other words, the polarization coincides here with a base polarization component of the retarder plate 2.

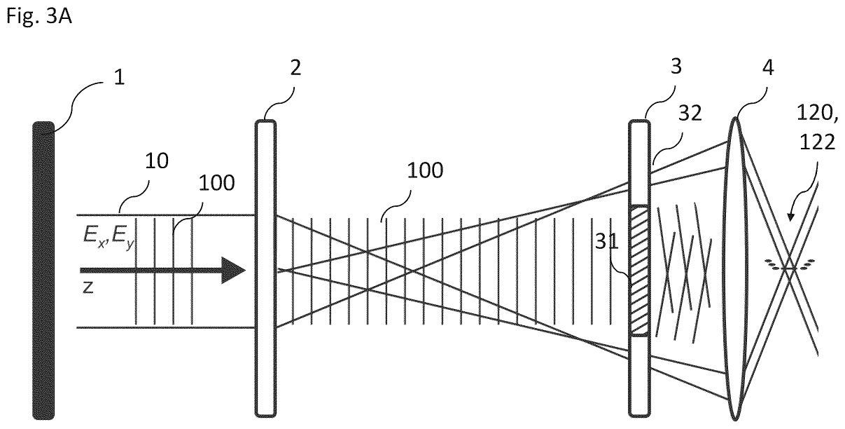

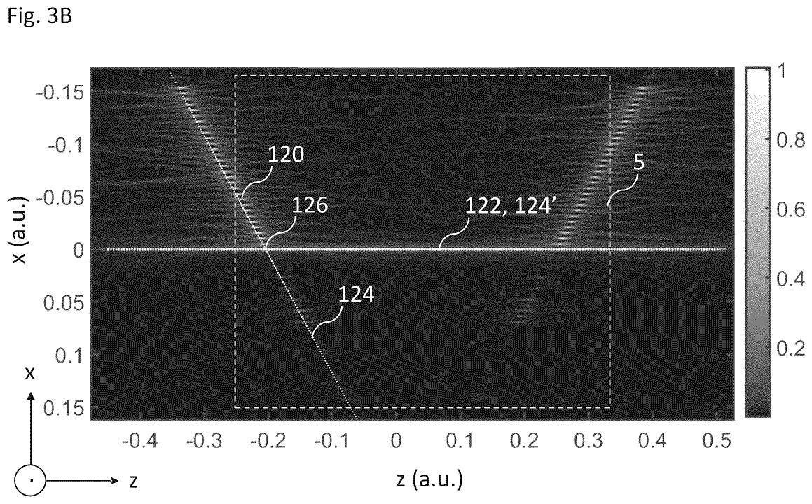

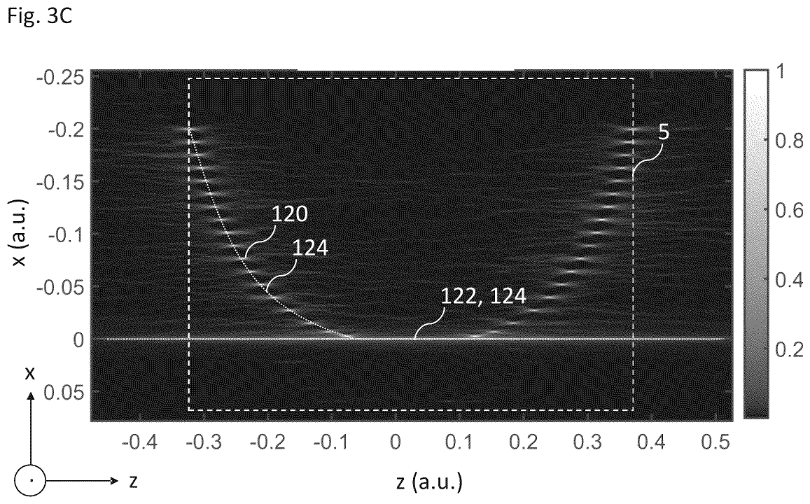

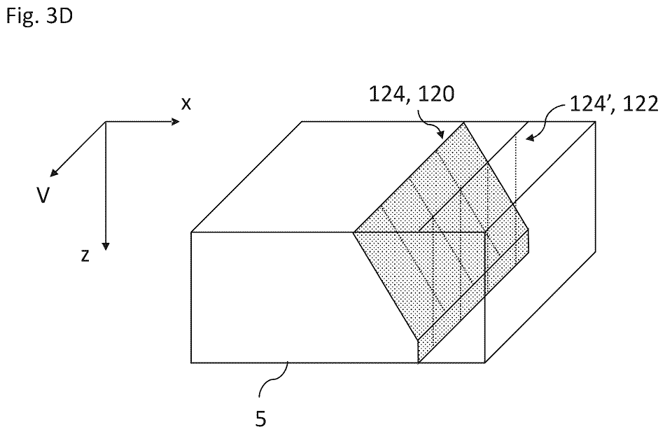

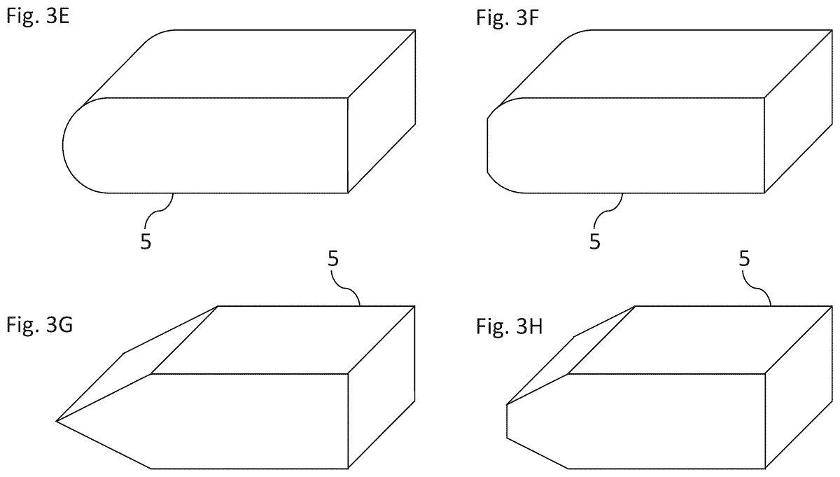

The general case is shown in FIG. 3A. In general, the polarization of the laser beam 10 is a superposition of two base polarizations, for example, of s-polarization and p-polarization. If both polarization components are present in the laser beam 10, a first location-dependent phase retardation is applied to the first polarization component and a second location-dependent phase retardation is applied to the second polarization component by the retarder plate 2.

A part of the laser beam 10 then propagates with a constant phase retardation to the first zone 31 of the beamforming element 3, while the part having the conical phase retardation propagates to the second zone 32 of the beamforming element 3. Accordingly, the partial laser beam which passes through the first zone 31 can be multiplied. In particular, a plurality of Gaussian focus zones 120 can thus be generated after the focusing device 4, which can be arranged along a separating line 124.

The partial laser beam having the conical phase retardation passes, for example, unobstructed through the second zone 32 of the beamforming element 3 and is then introduced by the focusing device 4 into an elongated focus zone 122.

FIGS. 3B and 3C show corresponding simulations of the resulting intensity distributions. In this case, the Gaussian focus zones 120 are aligned along the separating line 124, while the elongated focus zone 122 defines the separating line 124′. The separating lines 124, 124′ have a common intersection point 126.

FIG. 3D shows a three-dimensional representation of the separating lines 124, 124′. The separating line 124 of the Gaussian focus zones 120 is in the x-z plane. The corresponding separating lines 124 are placed parallel to one another in the workpiece 5 by the feed V along the y axis. The separating lines 124 thus define the separating plane. This is also true for the separating lines 124′ which are generated by the elongated focus zones 124′.

In particular, it is to be noted that the separating lines 124, 124′ do not have to overlap in the x-z plane as shown in FIGS. 3B, 3C, or do not have to have an intersection point 126. It is sufficient if the separating planes intersect. In particular, the Gaussian focus zones 120 and the elongated focus zone 122 can thus have different y coordinates. This is indicated in FIG. 3D by the different placement of the separating lines 124, 124′.

The intensities typically differ in the Gaussian focus zones 120 and the elongated focus zone 122. This is because, on the one hand, the laser beam 10 in the Gaussian focus zones 120 is concentrated on a significantly smaller spatial region, while the energy of the laser beam is distributed onto a large region in the elongated focus zones 122. Accordingly, it can be advantageous if a polarizer 6 is arranged in the beam path, so that the intensity in the Gaussian focus zones 120 and the elongated focus zone 122 can be set.

FIGS. 3E to 3H show different examples of possible bevels, which can be generated by the intensity distributions presented above in one processing pass. FIG. 3E shows a round bevel or C chamfer, for example, in that the workpiece 5 is symmetrically arranged in the intensity profile of FIG. 1D. In FIG. 3E a capped C chamfer is analogously generated, wherein the front part of the C chamfer is taken away by the additional elongated focus zone of the laser beam 10. The associated intensity distribution is shown in FIG. 3C. FIG. 3G shows a V chamfer which can be generated if the workpiece 5 is arranged symmetrically in the intensity profile of FIG. 1C. FIG. 3H analogously shows a capped V chamfer, which is generated in that the front part of the V chamfer is removed by the elongated focus zone of the laser beam 10. The associated intensity distribution is shown in FIG. 3B. In particular, the workpiece 5 does not have to be arranged symmetrically in the intensity distribution. Rather, only a one-sided chamfer can also be generated by an asymmetrical arrangement, as indicated in FIGS. 1C and 1D.

It is possible in particular to set the aperture angle of the V chamfer or the curvature of the C chamfer by a configuration of the retarder plate 2 in the production process.

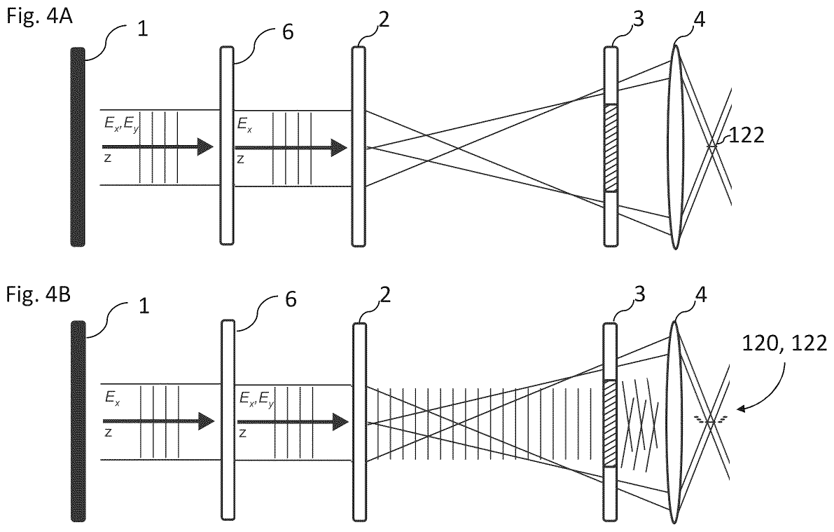

In FIG. 4A, for example, the laser beam 10 of the laser 1 is circularly polarized, thus equally has s-polarized and p-polarized components. A polarization component can be filtered out of the laser beam 10 in this case by a polarization filter 6. Depending on the setting of the polarization filter 6, the s-component or the p-component can be attenuated. If the first polarization component is attenuated, for example, the laser beam 10 having the first location-dependent phase retardation is thus also attenuated as a whole. Accordingly, the intensity in the Gaussian focus zones 120 would also be attenuated, while the intensity in the elongated focus zone 122 remains the same.

FIG. 4B shows the case that the laser 1 emits a linearly polarized laser beam 10. Elliptically polarized light can be generated from the linearly polarized light by a corresponding wave plate. In particular, the mixture of the polarization components can be set by adjusting the wave plate 6. Accordingly, the intensity in the Gaussian focus zones 120 and the elongated focus zone 122 can also be set.

In a further exemplary application, the various beam forms and focus zones can be used not only for separating and beveling, but rather for introducing material modifications and a subsequent separating step by applying a thermal gradient.

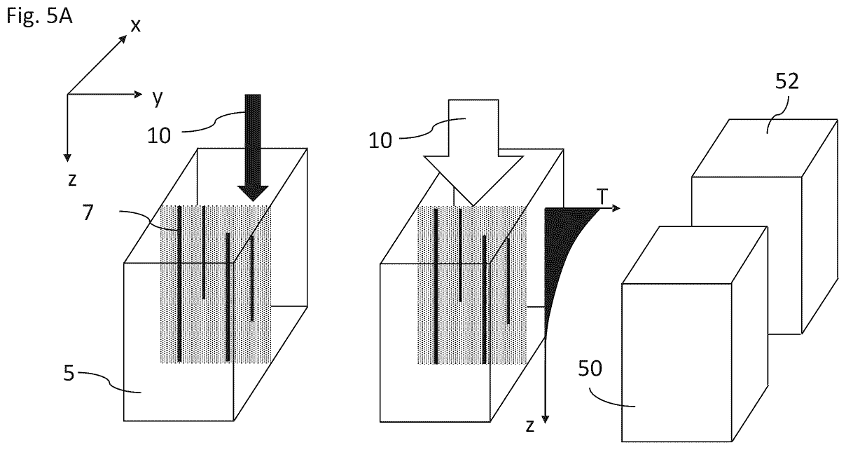

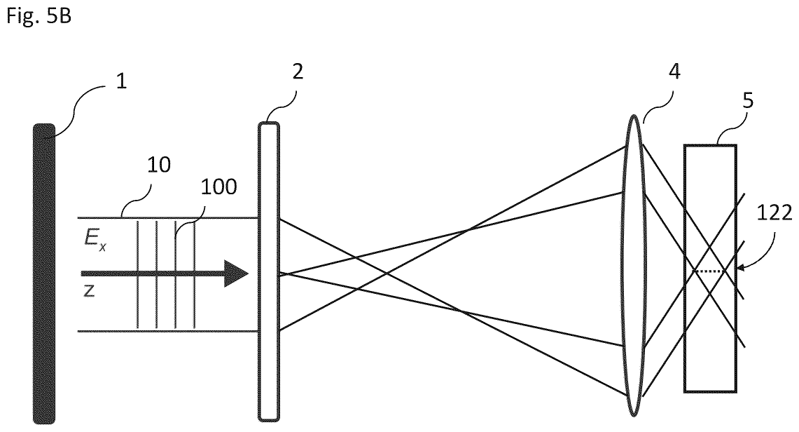

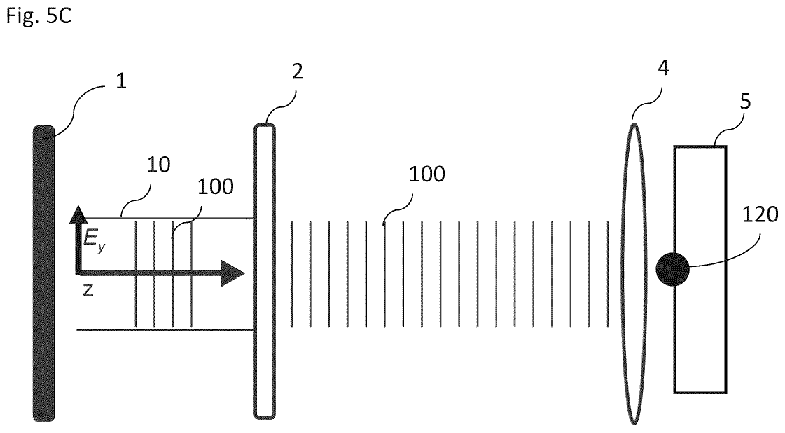

FIG. 5A shows how a laser beam 10 introduces material modifications 6 into the workpiece 5. The material modifications 6 which the laser beam 10 generates can have different shapes, which essentially correspond to the shape of the focus zones 120, 122. In particular, elongated material modifications 6 can be generated by the elongated focus zone 122 of the laser beam 10. The material modifications 6 can protrude, for example, through the entire thickness of the workpiece 5, however, it is also possible that material modifications 6 are only generated on the upper surface or the lower surface of the workpiece 5. For example, the elongated material modifications 6 can also lie in the workpiece 5, so that no surface has contact with the material modifications 6. A perforation of the workpiece 6 can be performed by a plurality of material modifications 6, along which the workpiece 6 can be separated, for example. The separation can be implemented here via the application of a thermal gradient, as shown hereinafter.

FIG. 5B shows the device for introducing the material modifications 6. In contrast to the previously discussed embodiments, a beamforming element 3 can be omitted in this embodiment. For example, the material modifications 6 can be performed here using a laser beam 10 having a second polarization, so that the retarder plate 2 generates a phase front which also has a conical component and a lenticular component here. The laser beam 10 can then be introduced into an elongated focus zone 122 by the focusing device 4. The elongated focus zone 122 lies in the volume of the workpiece 5 here, for example.

After the material modifications 6 have been introduced, a thermal gradient can be generated via the material modifications 6, as shown in FIG. 5C. For this purpose, the laser beam 10 having a first polarization can penetrate the retarder plate 2, so that a constant phase retardation is applied to the laser beam 10. The constant phase retardation is finally translated by the focusing device into a Gaussian focus zone 120.

The focus zone 120 can be placed a few micrometers below the surface to generate the thermal gradient, so that the splitting of the workpiece takes place with little damage and a smooth broken edge results.

For example, FIG. 5A correspondingly shows that the temperature T is greater at the upper surface of the workpiece than at the lower surface. A temperature gradient thus results between the two surfaces and therefore a thermal gradient. Due to the thermal expansion, which is linear in the temperature in a first approximation, the workpiece 5 expands more strongly at the upper surface than at the lower surface. Material stresses of different strengths thus occur in the beam propagation direction.

The different material stresses run in FIG. 5A through the introduced material modifications 6. The material stresses can preferably relax there, which results in a crack formation. The crack formation advantageously takes place here between the various adjacent material modifications 6, so that the workpiece 5 is separated along the separating plane into two parts 50, 52 by the induced crack formation.

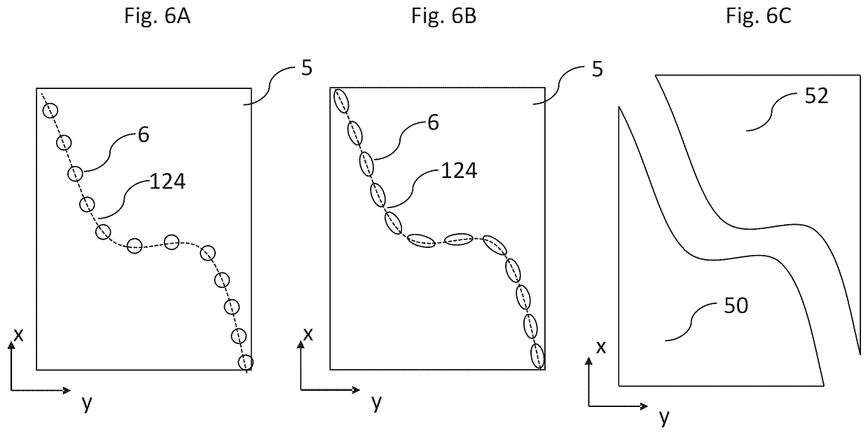

FIG. 6A shows the separating process in the x-y plane. The material modifications 6 are also introduced here into the workpiece 5 along the separating line 124. In FIG. 6A, the material modifications 6 are formed round, however, they can also have an elliptical cross-section, for example, so that they have a long axis which is preferably tangential to the separating line, as shown in FIG. 6B.

Since the material modifications 6 are placed adjacent to one another along the separating line 124 or the workpiece 5 is perforated along the separating line 124, the crack propagates upon application of the thermal gradient from material modification 6 to material modification 6, so that the crack substantially follows the separating line 124.

FIG. 6C shows that the workpiece 5 can be separated into a first half 50 and a second half 52 by the application of a thermal gradient. The broken edge now results along the original separating line 124, which has a very high quality, in particular a low roughness, with the provided method.

Insofar as applicable, all individual features presented in the exemplary embodiments may be combined with one another and/or interchanged, without departing from the scope of the invention.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 laser
10 laser beam
100 phase front
120 focus zone
122 elongated focus zone
124 separating line
140 far field ring
2 retarder plate
20 nanograting
200 birefringent structure
3 beamforming element
31 first zone
32 second zone
4 focusing device
5 workpiece
50 first half
52 second half
6 material modification

1. A device for processing a workpiece using a laser beam of a laser, the device comprising:
a retarder plate, and
a focusing device, wherein
the retarder plate is configured to apply a first location-dependent phase retardation to a first part of the laser beam having a first input polarization, and to apply a second location-dependent phase retardation to a second part of the laser beam having a second input polarization,
the focusing device is configured to focus the laser beam in at least one focus zone, wherein a beam form of the laser beam in the focus zone is determined by the first location-dependent phase retardation and the second location-dependent phase retardation,
the at least one focus zone at least partially overlaps with the workpiece, and
the workpiece is subjected to laser radiation in the at least one focus zone and is thus processed.

2. The device as claimed in claim 1, wherein the first location-dependent phase retardation is conical and lenticular, and/or the second location-dependent phase retardation is constant,
wherein the first second part of the laser beam having the constant second location-dependent phase retardation has a Gaussian beam form in the focus zone, and/or the first part of the laser beam having the conical first location-dependent phase retardation has a non-diffractive beam form in the focus zone.

3. The device as claimed in claim 1, wherein the retarder plate has a location-dependent birefringent structure,
wherein the retarder plate provides the first location-dependent phase retardation and the second location-dependent phase retardation by local polarization projection of the laser beam on the location-dependent birefringent structure of the retarder plate.

4. The device as claimed in claim 3, wherein the location-dependent birefringent structure is a nanograting, wherein the nanograting is provided in a transparent carrier material as a type 2 modification.

5. The device as claimed in claim 1, further comprising a polarizer element configured to set a polarization of the laser beam,
wherein the polarizer element is arranged after or before the focusing device, and/or before the retarder plate.

6. The device as claimed in claim 1, further comprising a beamforming element configured to form and/or multiply the laser beam,
wherein the beamforming element is arranged after the retarder plate in a beam propagation direction,
wherein the beamforming element has at least a first zone and a second zone,
wherein the first zone is configured to perform a first beam multiplication and/or beamforming, thereby providing the first part of the laser beam, and
wherein the second zone is configured to perform a second beam multiplication and/or beamforming, thereby providing the second part of the laser beam.

7. The device as claimed in claim 6, wherein the first beam multiplication of the laser beam is performed by the first zone of the beamforming element,
wherein the at least one focus zone is arranged by the first zone of the beamforming element in three spatial dimensions along a separating line.

8. The device as claimed in claim 7, wherein the first zone of the beamforming element is a 3D beam splitter.

9. The device as claimed in claim 6, wherein the beamforming element is a diffractive optical element.

10. The device as claimed in claim 6, wherein the first zone of the beamforming element receives the second part of the laser beam having a constant phase retardation, and after the focusing device, provides a plurality of Gaussian focus zones arranged along a separating line.

11. The device as claimed in claim 6, wherein the second zone of the beamforming element receives the first part of the laser beam having a conical phase retardation, and after the focusing device, provides the focus zone elongated in a beam propagation direction.

12. The device as claimed in claim 11, wherein a separating line and a feed define a first separating plane, and the elongated focus zone and the feed define a second separating plane, wherein the first separating plane and the second separating plane intersect,
due to which the workpiece is simultaneously separated along the focus zone elongated in the beam propagation direction and beveled along the separating line.

13. The device as claimed in claim 6, wherein the first zone is a central zone and the second zone is a neutral outer zone.

14. A method for separating a workpiece by using a laser beam of a laser, the method comprising:
applying a first location-dependent phase retardation to a first part of the laser beam having a first input polarization by using a retarder plate, and
applying a second location-dependent phase retardation to a second part of the laser beam having a second input polarization by using the retarder plate, and
focusing the laser beam using a focusing device in at least one focus zone, wherein a beam form of the laser beam in the focus zone is determined by the first location-dependent phase retardation and the second location-dependent phase retardation,
wherein the at least one focus zone at least partially overlaps with the workpiece, and a material of the workpiece is subjected to laser radiation in the at least one focus zone, thereby the workpiece is processed.

15. The method as claimed in claim 14, wherein the first location-dependent phase retardation is conical and lenticular, and/or the second location-dependent phase retardation is constant, and the second part of the laser beam having the constant second location-dependent phase retardation is mapped by the focusing device in a Gaussian focus zone, and/or the first part of the laser beam having the conical first location-dependent phase retardation is mapped in the focus zone elongated in a beam propagation direction.

16. The method as claimed in claim 15, further comprising:
generating the first part of the laser beam having the focus zone elongated in the beam propagation direction using the first input polarization, wherein the beam propagation direction is oriented perpendicular to a material surface, and material modifications are introduced into the workpiece by application to the workpiece, and
generating at least one Gaussian focus zone using the second input polarization, wherein the Gaussian focus zone overlaps with at least one material modification, and
separating the workpiece along the material modifications by thermal application in the focus zone.

17. The method as claimed in claim 16, further comprising transferring the second part of the laser beam having a constant phase retardation into a plurality of Gaussian focus zones using a beamforming element, wherein the plurality of Gaussian focus zones are arranged in three spatial dimensions along a separating line, which is at an angle to a beam propagation direction, due to which the workpiece is beveled.

18. The method as claimed in claim 17, further comprising transferring the first part of the laser beam having a conical phase retardation into an elongated focus zone, by which the workpiece is separated.

19. The method as claimed in claim 18, wherein the first part and the second part of the laser beam having mixed polarizations simultaneously bevel and separate the workpiece, wherein relative powers of the first part and the second part of the laser beam are set by setting a polarization of the laser beam.
